(19) United States
(12) Patent Application Publication
(10) Pub. No.: US 2012/0151108 A1
(43) Pub. Date: Jun. 14, 2012

(54) DATA PROCESSING SYSTEM

(75) Inventor: Yuki SOGA, Kyoto (JP)

(73) Assignee: Panasonic Corporation, Osaka (JP)

(21) Appl. No.: 13/396,242

(22) Filed: Feb. 14, 2012

Related U.S. Application Data
(63) Continuation of application No. PCT/JP2010/002220, filed on Mar. 26, 2010.

(30) Foreign Application Priority Data
Oct. 6, 2009 (JP) 2009-232514

(51) Int. Cl. G06F 13/00

(52) U.S. Cl. 710/110

(57) ABSTRACT

A transfer canceler is provided on a bus connecting a master and a slave together. The transfer canceler interrupts the bus so that an invalid command flowing through the bus does not reach the slave when the master is in the reset state, and at the same time, generates and receives data to and from the slave corresponding to an access request command which has been output to the slave on behalf of the master disabled by resetting. In addition, in order to more quickly complete a process which has been issued to the slave, a circuit is additionally provided which temporarily changes an arbitration priority level or an operating frequency of the slave.

### CROSS-REFERENCE TO RELATED APPLICATIONS

This is a continuation of PCT International Application PCT/JP2010/002220 filed on Mar. 26, 2010, which claims priority level to Japanese Patent Application No. 2009-232514 filed on Oct. 6, 2009. The disclosures of these applications including the specifications, the drawings, and the claims are hereby incorporated by reference in their entirety.

### BACKGROUND

The present disclosure relates to data processing systems in which one or a plurality of masters access a slave and which have a mechanism for resetting and restoring each master during operation.

In a system LSI, if one or more masters share one or a plurality of slaves via buses, it is necessary to provide a function of resetting a master during operation of the system if a malfunction occurs in the master. Here, the master is a microprocessor, a digital signal processor (DSP), or a direct memory access (DMA) controller, etc., and the slave is a memory (e.g., a synchronous dynamic random access memory (SDRAM), etc.) or a peripheral input/output (I/O) controller, etc.

There is a conventional technique in which when a malfunction occurs in a master connected to a bus and the master is reset, the entire system including masters and slaves is temporarily stopped, malfunction information is collected, and a required register is reset and cleared, whereby the master is restored from the malfunction (see Japanese Patent Publication No. H11-312102).

In contrast to this, there is a known technique in which, on a bus which connects a master and a slave together, a circuit is provided which completes command transfer on behalf of the master when a malfunction occurs in the master and the master is reset (see Japanese Patent Publication No. 2008-234189). There is also a known technique in which a circuit is provided which receives a response signal, such as read data, etc., from a slave on behalf of a master (see Japanese Patent Publication No. 2008-250632). With these techniques, when a malfunction occurs in a master and the master is reset, a process which has been issued to a slave and has not been completed is normally ended, and the master is restored without stopping the entire system including the slave. At the same time, the desired restoration operation can be achieved by adding the circuit to the bus without changing the function of the slave. These techniques are particularly effective when the function of the slave cannot actually be changed.

An operation of normally completing a command which remains uncompleted in a slave during resetting of a master and thereby erasing the uncompleted command is hereinafter referred to as “transfer canceling.”

In the above conventional techniques, in order to erase a process which has been issued to a slave and has not been completed, a circuit for completing, on behalf of a master, the process instead of resetting the slave is added. Therefore, there is a problem that, compared to when the function of a slave is changed and the uncompleted process is directly erased, a period of time which it takes to normally complete the process is additionally required.

### SUMMARY

The present disclosure describes implementations of a data processing system in which a process which has been issued to a slave can be quickly completed.

An example data processing system includes a plurality of masters and a slave configured to communicate and exchange data with each other, a plurality of transfer cancelers each interposed between a corresponding one of the plurality of masters and the slave, and configured to, when any of the plurality of masters is in a state in which data transfer operation is disabled, allow the slave to perform and complete operation on behalf of the disabled master or masters, and a canceling linkage section configured to control a linkage between the plurality of transfer cancelers. Each of the plurality of transfer cancelers includes a bus interrupter configured to interrupt command issuance and data output from the corresponding master to the slave, a data generator configured to generate data to be sent out to the slave in response to a command issued to the slave on behalf of the corresponding master, a data absorber configured to receive response data from the slave corresponding to the command issued to the slave on behalf of the corresponding master, a slave setting section configured to generate setting data for setting an operating state of the slave during operation of the data generator and the data absorber, a setting switching section configured to switch setting data between the setting data generated by the slave setting section and setting data which is used when the data generator and the data absorber are not operating, and a transfer canceling controller configured to monitor internal states of and control the bus interrupter, the data generator, the data absorber, the slave setting section, and the setting switching section. The canceling linkage section has a function of collecting internal states of the plurality of transfer cancelers from the respective transfer canceling controllers thereof, and notifying the plurality of transfer cancelers of the internal states, and the data generator has a function of generating setting data based on the internal states of the plurality of transfer cancelers notified of by the canceling linkage section.

Another example data processing system includes a plurality of masters and a slave configured to communicate and exchange data with each other, and a plurality of transfer cancelers each interposed between a corresponding one of the plurality of masters and the slave, and configured to, when any of the plurality of masters is in a state in which data transfer operation is disabled, allow the slave to perform and complete operation on behalf of the disabled master or masters. Each of the plurality of transfer cancelers includes a bus interrupter configured to interrupt command issuance and data output from the corresponding master to the slave, a data generator configured to generate data to be sent out to the slave in response to a command issued to the slave on behalf of the corresponding master, a data absorber configured to receive response data from the slave corresponding to the command issued to the slave on behalf of the corresponding master, a command transfer section configured to change connections between a first bus connected to the master, a second bus connected to the slave, and a third bus, and a transfer canceling controller configured to monitor internal states of and control the bus interrupter, the data generator, the data absorber, and the command transfer section. The command transfer section controls the switching of the bus connections based on the internal states notified of by the transfer canceler.

Still another example data processing system includes a master and a slave configured to communicate and exchange data with each other, and a transfer canceler interposed between the master and the slave, and configured to, when the master is in a state in which data transfer operation is disabled, allow the slave to perform and complete operation on behalf of the master. The transfer canceler includes a bus interrupter configured to interrupt command issuance and data output from the master to the slave, a data generator configured to generate data to be sent out to the slave in response to a command issued to the slave on behalf of the master, a data absorber configured to receive response data from the slave corresponding to the command issued to the slave on behalf of the master, a command storage section configured to store data communication which needs to be performed and completed on behalf of the master, and control the bus interrupter, the data generator, and the data absorber so that the bus interrupter, the data generator, and the data absorber operate only with respect to the stored data communication, and a transfer canceling controller configured to control the bus interrupter, the data generator, the data absorber, and the command storage section.

According to the present disclosure, an operating state of the slave is set during operation of the data generator and the data absorber, whereby the transfer canceling operation can be accelerated.

The operation of each bus interrupter which interrupts command issuance and data output from the corresponding master to the slave is separately controlled, whereby a process conflict between the plurality of masters in the shared slave can be reduced, and therefore, the transfer canceling operation can be accelerated.

A command from a master is transferred to a transfer canceler corresponding to another master, whereby a master under transfer canceling can access the shared slave via a port for another master, and therefore, operation from stopping to restoration of the master can be accelerated.

Data communication which needs to be performed and completed on behalf of a master is stored, and the bus interrupter, the data generator, and the data absorber are allowed to operate only with respect to the stored data communication, whereby an uncompleted process can be selectively erased, and therefore, operation from stopping to restoration of the master can be accelerated.

### BRIEF DESCRIPTION OF THE DRAWINGS

FIG. 1 is a block diagram showing a configuration of an electronic device having a data processing system according to a first embodiment of the present disclosure.

FIG. 2 is a block diagram showing a detailed example configuration of a setting switching section of FIG. 1.

FIG. 3 is a flowchart showing operation of the data processing system of FIG. 1.

FIG. 4 is a block diagram showing a configuration of an electronic device having a data processing system according to a second embodiment of the present disclosure.

FIG. 5 is a flowchart showing operation of the data processing system of FIG. 4.

FIG. 6 is a block diagram showing a configuration of an electronic device having a data processing system according to a third embodiment of the present disclosure.

FIG. 7 is a flowchart showing operation of the data processing system of FIG. 6.

FIG. 8 is a block diagram showing a configuration of an electronic device having a data processing system according to a fourth embodiment of the present disclosure.

FIG. 9 is a flowchart showing operation of the data processing system of FIG. 8.

### DETAILED DESCRIPTION

### First Embodiment

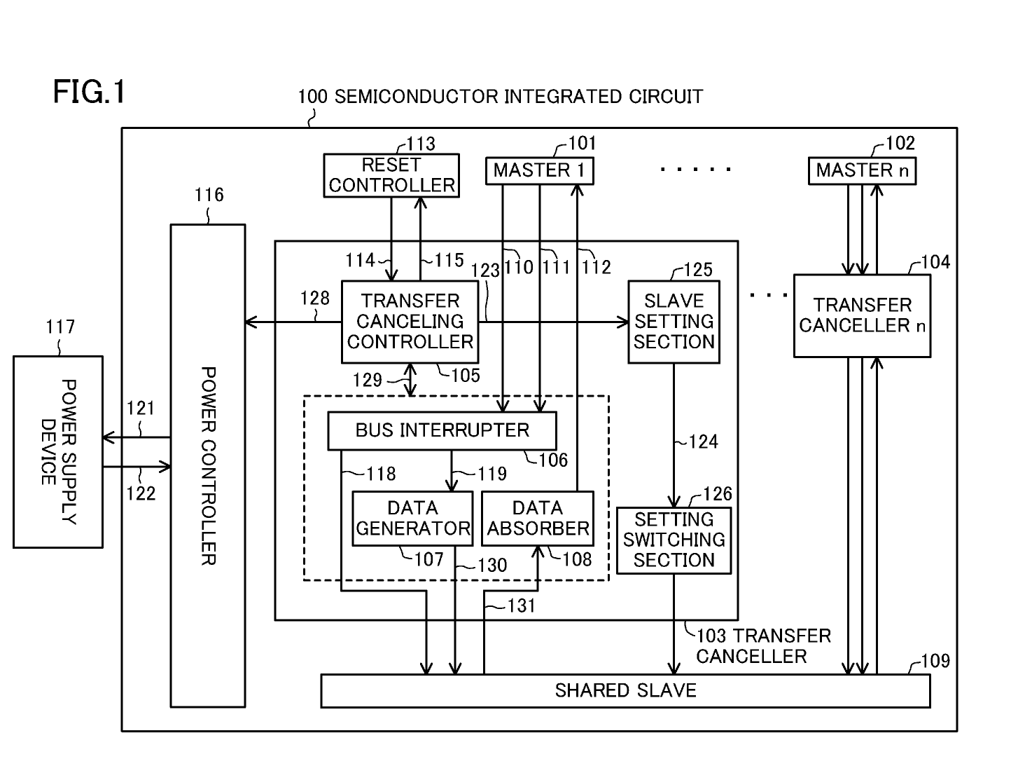

FIG. 1 shows a configuration of an electronic device having a data processing system according to a first embodiment of the present disclosure. As used herein, the term “electronic device” refers to any device, such as a mobile telephone, a DVD recorder, etc.

The electronic device of FIG. 1 includes a power supply device 117, and a semiconductor integrated circuit 100 including a power controller 116. The power supply device 117 supplies power to the semiconductor integrated circuit 100 via a power line 122. The power controller 116 distributes power to each block of the semiconductor integrated circuit 100, and controls power supplied from the power supply device 117 based on a state of each block, via a power control signal line 121.

Next, an internal configuration of the semiconductor integrated circuit 100 will be described in detail. The semiconductor integrated circuit 100 of FIG. 1 includes, in addition to the power controller 116, a plurality of masters 101 and 102, a plurality of transfer cancelers 103 and 104, a shared slave 109, and a reset controller 113. The masters 101 and 102 are each, for example, a microprocessor, a digital signal processor (DSP), or a direct memory access (DMA) controller, etc. The shared slave 109 is, for example, a memory or a peripheral input/output (I/O) controller, etc. Note that, for the sake of simplicity, FIG. 1 does not show masters other than the two masters 101 and 102, or transfer cancelers other than the two transfer cancelers 103 and 104.

The master 101 and the shared slave 109 are connected together via buses 110, 111, and 112. Of these buses, the command bus 110 transmits an access request command to the shared slave 109, the write data bus 111 transmits write data to the shared slave 109, and the read data bus 112 transmits read data from the shared slave 109. The master 102, which shares the shared slave 109, is also connected to the shared slave 109 via a command bus, a write data bus, and a read data bus.

The reset controller 113 is a block which controls resetting of the masters 101 and 102 and the shared slave 109. The reset controller 113 is connected to the transfer canceler 103 via signal lines 114 and 115, and transmits and receives a control signal to and from the transfer canceler 103. Similarly, the transfer canceler 104 is connected to the reset controller 113 via signal lines (not shown), and transmits and receives a control signal to and from the reset controller 113.

The transfer canceler 103 is provided on the buses 110, 111, and 112 which connect the master 101 and the shared slave 109 together. Similarly, the transfer canceler 104 is provided on buses which connect the master 102 and the shared slave 109 together.

The transfer canceler 103 includes a transfer canceling controller 105, a bus interrupter 106, a data generator 107, a data absorber 108, a slave setting section 125, and a setting switching section 126.

The transfer canceling controller 105 receives an instruction from the reset controller 113 via the signal line 114, and controls (e.g., starts, ends, etc.) operation of each block in the transfer canceler 103 via a signal line 123 or 129. The transfer canceling controller 105 also notifies the reset controller 113 of a state (e.g., completion of transfer canceling, etc.) of the transfer canceler 103 via the signal line 115. Similarly, the transfer canceling controller 105 also notifies the power controller 116 of a state of the transfer canceler 103 via a signal line 128.

The power controller 116 checks whether or not each block of the semiconductor integrated circuit 100 is operating, based on a state signal from each block including information of the signal line 128, thereby determining a block or blocks which require power supply. For example, if all the masters 101 and 102 stop accessing the shared slave 109 and the transfer canceler 103 is not performing transfer canceling operation, power consumption can be reduced by stopping the supply of power to the shared slave 109 and the transfer canceler 103.

The bus interrupter 106 stops receiving data from the command bus 110 and the write data bus 111 under the control of the transfer canceling controller 105, to perform bus interruption so that the data is not transferred to the shared slave 109. For example, if a command and data are transferred through the command bus 110 and the write data bus 111 by a handshake between a transmission request signal from the master 101 and a reception enable signal from the shared slave 109, the bus interrupter 106 achieves bus interruption by negating the reception enable signal to be sent out to the master 101 and the transmission request signal to be sent out to the shared slave 109. A command output signal line 118 and a write data output signal line 119 from the bus interrupter 106 correspond to the command bus 110 and the write data bus 111, respectively. The bus interrupter 106 achieves bus interruption by not sending out a command and data transferred from the buses 110 and 111 to the output signal lines 118 and 119. During normal operation, the bus interrupter 106 passes a command and data transmitted through the command bus 110 and the write data bus 111 directly to the output signal lines 118 and 119.

The data generator 107 receives a transfer canceling instruction from the transfer canceling controller 105 to generate dummy data for the shared slave 109 on behalf of the master 101, which has been reset and stopped. For example, if data is transferred through the write data bus 111 by a handshake between a transmission request signal from the master 101 and a reception enable signal from the shared slave 109, and the shared slave 109 is not allowed to receive more than a data transfer amount of data which is requested by a received command, dummy data can be generated by invariably asserting the transmission request signal from the data generator 107 to the shared slave 109. The generated dummy data is transferred via a signal line 130 to the shared slave 109. When transfer canceling is not performed, the data generator 107 transfers data received via the data signal line 119 directly to the signal line 130.

The data absorber 108 receives a transfer canceling instruction from the transfer canceling controller 105, and receives data sent from the shared slave 109 via a signal line 131 on behalf of the master 101, which has been reset and stopped. For example, if data is transferred through the read data bus 112 by a handshake between a reception enable signal from the master 101 and a transmission request signal from the shared slave 109, similar to the command bus 110 and the write data bus 111, a reception enable signal from the data absorber 108 to the shared slave 109 may be invariably asserted. When transfer canceling is not performed, data from the signal line 131 is transferred directly to the read data bus 112.

The slave setting section 125 receives a transfer canceling instruction from the transfer canceling controller 105, and generates setting data for changing the operation mode of the shared slave 109 in order to accelerate transfer canceling operation. The generated data is send via a signal line 124 to the setting switching section 126.

For example, if the priority level of command selection among a plurality of masters to which the shared slave 109 is connected can be externally set in the shared slave 109, the slave setting section 125 generates setting data for temporarily increasing the priority level of a master on which transfer canceling is to be performed. As a master whose priority level is decreased instead of increasing the priority level of the master on which transfer canceling is to be performed, a master which is previously expected not to operate during canceling of the master on which transfer canceling is to be performed, or a master which requests only an allowable transfer band from the shared slave 109, etc. is selected. For a master whose priority level has been increased during a transfer canceling period, the priority level may be decreased for a predetermined period of time after the end of transfer canceling, i.e., the master receives a penalty. If the shared slave 109 has a function of changing operating frequencies, depending on settings, the slave setting section 125 generates setting data for increasing the operating frequency of the shared slave 109.

The setting data for the shared slave 109 generated by the slave setting section 125 is sent via the setting switching section 126 to the shared slave 109. The setting switching section 126 switches a set value between one which is used when transfer canceling is not performed and one which is output from the slave setting section 125, depending on a control signal from the transfer canceling controller 105.

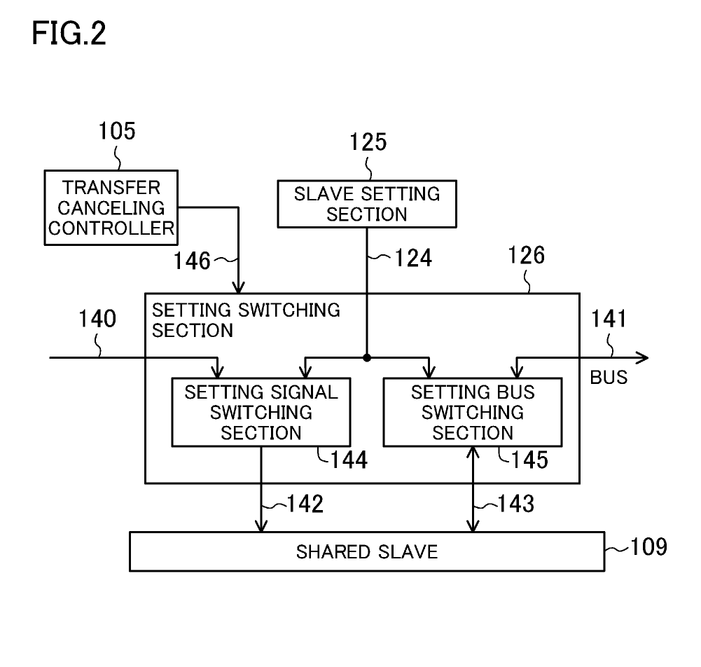

FIG. 2 shows an internal configuration of the setting switching section 126. Either or both of a setting signal switching section 144 and a setting bus switching section 145 are provided, depending on a process of setting the shared slave 109.

If the process of setting the shared slave 109 is to input a value to an input port of the shared slave 109, the setting signal switching section 144 switches a signal line between a signal line 140 through which a set value is input during normal operation and the signal line 124 through which setting data is transmitted from the slave setting section 125, depending on a value of a control signal 146 from the transfer canceling controller 105, before outputting a signal to a signal line 142. A source which generates the set value which is input through the signal line 140 may be a register, the masters 101 and 102, or a fixed value input, etc., which are provided in the semiconductor integrated circuit 100. If the value is only changed, the setting signal switching section 144 is a simple selector circuit. If a procedure is required for switching of the settings, a sequencer for the procedure is provided in the setting signal switching section 144.

If the process of setting the shared slave 109 is to write data to a register in the shared slave 109 via a bus, the setting bus switching section 145 switches buses based on the bus protocol. For example, if a master device, such as a microcomputer, etc., which is provided in the semiconductor integrated circuit 100 accesses the shared slave 109 via a bus 141, the setting bus switching section 145 outputs a value of the slave setting section 125 to a bus 143 based on the transfer protocol of the bus 141 during transfer canceling, to set the shared slave 109. During normal operation other than transfer canceling, the bus 141 is connected directly to the bus 143.

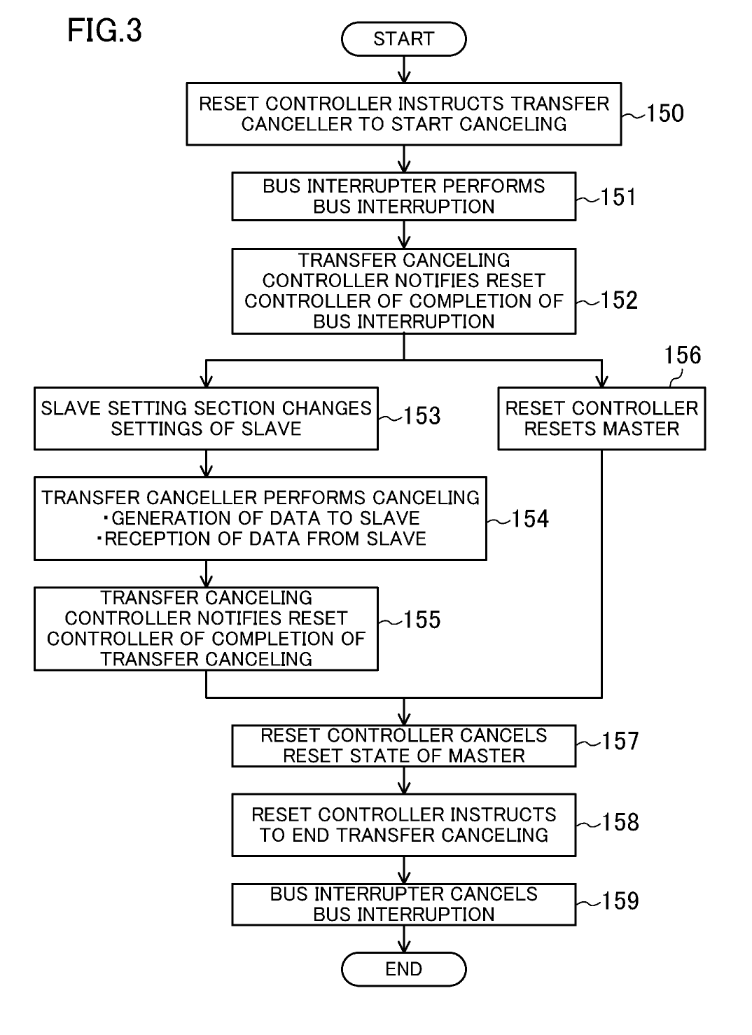

FIG. 3 shows an example flow of transfer canceling and resetting of the master 101 using the mechanism of FIGS. 1 and 2. Initially, in step 150, the reset controller 113 notifies the transfer canceling controller 105 in the transfer canceler 103, via the signal line 114, that it is necessary to reset the master 101 and therefore transfer canceling is to be performed. In response to this, in step 151, the transfer canceling controller 105 initially instructs the bus interrupter 106 to perform bus interruption, and the bus interrupter 106 performs bus interruption so that invalid data is not transferred from the master 101 to the shared slave 109. After the bus interruption has been completed, in step 152 the transfer canceling controller 105 notifies the reset controller 113 of the completion of the bus interruption via the signal line 115.

After the bus interruption has been completed, in step 156 the reset controller 113 issues an instruction to reset the master 101. In parallel to step 156, in step 153 the slave setting section 125 and the setting switching section 126 changes setting values for the shared slave 109. Thereafter, in step 154, the data generator 107 and the data absorber 108 in the transfer canceler 103 are activated to complete and erase an uncompleted process remaining in the shared slave 109 on behalf of the master 101. After the transfer canceling has been thus completed, in step 155 the transfer canceling controller 105 notifies the reset controller 113 of the completion of the transfer canceling via the signal line 115.

Next, in step 157, the reset controller 113 cancels the reset state of the master 101. Thereafter, in step 158, the reset controller 113 instructs the transfer canceling controller 105 to end the transfer canceling state. In response to this, in step 159, the transfer canceler 103 cancels the bus interruption.

With the above steps, when the master 101 is reset, it is possible to erase a command remaining in the shared slave 109, without altering the shared slave 109 in order to provide, for example, a special mechanism for resetting a slave or a part of the slave, and at the same time, it is possible to accelerate transfer canceling by providing the slave setting section 125 and the setting switching section 126. For example, if the slave setting section 125 gives an access command of the master 101 a higher priority level than those of other commands during operation of the data generator 107 and the data absorber 108, the transfer canceling operation can be accelerated. Also, the process can be accelerated by increasing the operating clock frequency of the shared slave 109.

Although FIG. 1 shows two masters and one shared slave, there may actually be any number of masters and shared slaves. The buses may be in various forms, such as a multilayer bus, etc. The buses may be provided in various forms, such as an interconnect in a system LSI, an interconnect on a substrate, etc., or may be a network, such as a local area network (LAN), etc., which connects electronic devices. Although, in FIG. 1, the transfer canceler is provided between each of all masters and a slave, for each master it may be determined whether or not the transfer canceler is provided between that master and the slave.

Although, in FIG. 1, the reset controller 113 issues a command to the transfer canceler 103 via the signal line 114, a master such as a microprocessor, etc., may do so. All the transfer cancelers 103 and 104 may be controlled by a single block or separate blocks. Although the transfer canceling controller 105 notifies the reset controller 113 of the state of the transfer canceler 103 via the signal line 115, a register which can be read from a microprocessor may be provided to notify the microprocessor, or the microprocessor may be notified of by interruption. The bus 112 may transmit, in addition to read data, a response signal, such as a signal which is used to notify of completion of a write process in the shared slave 109, etc.

In the above description, the bus interrupter 106 does not receive a command or data from the master 101 during transfer canceling, and the master 101 continues to have the command and the data, and the command and the data are erased by resetting the master 101. Alternatively, the bus interrupter 106 may temporarily receive the command and the data, and the command and the data may be erased in the bus interrupter 106. In this case, a reception enable signal to the master 101 is asserted, and a transmission request signal to the shared slave 109 is negated.

Examples of the inter-master priority level information generated by the slave setting section 125 include, in addition to the priority level which is used to select commands from masters connected to the shared slave 109, any information which is used to determine a priority level for arbitration between accesses from the masters 101 and 102 in the shared slave 109, such as information for limiting the number of commands received from masters during a predetermined period of time, information about bands (data amounts during a predetermined period of time) of the shared slave 109 allocated for masters, etc. In the above example, the priority level of a master to be canceled is increased. Alternatively, for example, if there is a limit on the order of command processing of masters, a command to the master to be canceled may eventually be more quickly processed by giving a priority to the process of another master. Therefore, various set values may be contemplated, depending on characteristics of the shared slave 109 and the masters 101 and 102.

If the shared slave 109 is configured to receive more than an amount of data requested by a received command, the data generator 107 may have a function of calculating how much the amount of data is short for the preceding command, and may send out information only about the data shortfall to the shared slave 109.

In the operation flow of FIG. 3, step 153 may be performed anywhere between the bus interruption of step 151 and the completion of transfer canceling of step 155. The detection of the completion of transfer canceling of step 155 may be achieved by a technique of monitoring an output signal indicating an internal state of the shared slave 109, a technique of storing a command to be canceled in a command storage section described below, and monitoring the completion of data transfer corresponding to the stored command, a technique of detecting that data transfer is not performed for a predetermined period of time, by monitoring the buses 110, 111, and 112, etc.

### Second Embodiment

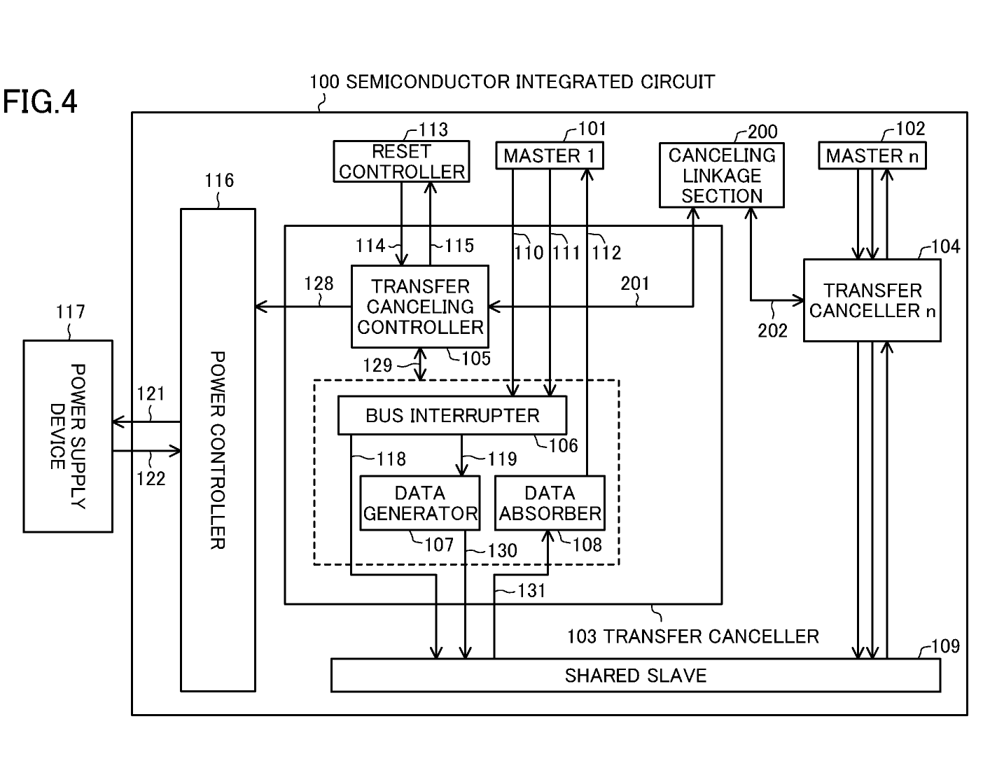

FIG. 4 shows a configuration of an electronic device having a data processing system according to a second embodiment of the present disclosure. In FIG. 4, a canceling linkage section 200 which establishes a linkage between the transfer cancelers 103 and 104 of masters is provided instead of the slave setting section 125 and the setting switching section 126 in the semiconductor integrated circuit 100 of FIG. 1.

The canceling linkage section 200 is connected to the transfer canceling controllers 105 of the transfer cancelers 103 and 104 via signal lines 201 and 202, respectively. The transfer canceling controller 105 notifies the canceling linkage section 200 of a state of transfer canceling. The canceling linkage section 200 notifies the transfer canceling controller 105 of a master on which transfer canceling is not to be performed of the transfer canceling state of a master on which transfer canceling is to be performed, and issues an instruction to perform or cancel bus interruption to the transfer canceling controller 105 of the master on which transfer canceling is not to be performed.

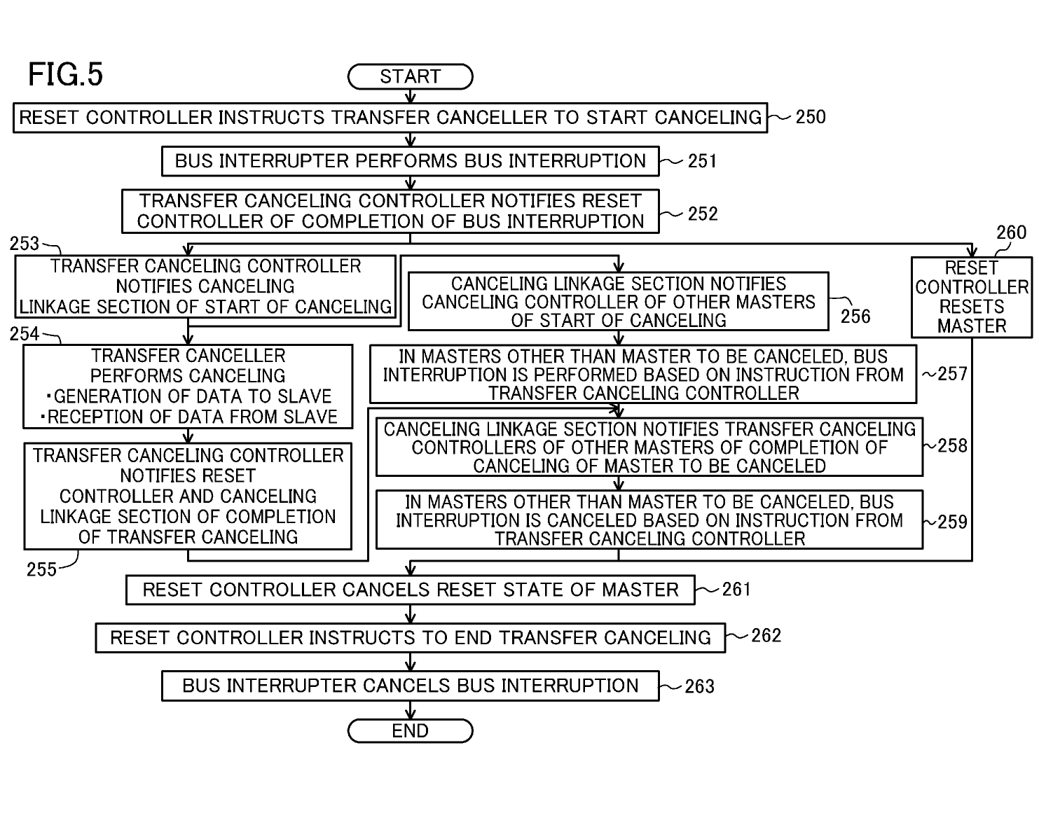

FIG. 5 shows an example flow of transfer canceling and resetting of the master 101 using the mechanism of FIG. 4. Initially, in step 250, the reset controller 113 notifies the transfer canceling controller 105 in the transfer canceler 103, via the signal line 114, that it is necessary to reset the master 101 and therefore transfer canceling is to be performed. In response to this, in step 251, the transfer canceling controller 105 initially instructs the bus interrupter 106 to perform bus interruption, and the bus interrupter 106 performs bus interruption so that invalid data is not transferred from the master 101 to the shared slave 109. After the bus interruption has been completed, in step 252 the transfer canceling controller 105 notifies the reset controller 113 that the bus interruption has been performed.

After the bus interruption has been completed, in step 260 the reset controller 113 resets the master 101. In parallel to step 260, in step 253 the transfer canceling controller 105 notifies the canceling linkage section 200 of the start of the transfer canceling process. Thereafter, in parallel to the transfer canceling process of the transfer canceler 103 in step 254, in step 256 the canceling linkage section 200 notifies the transfer canceling controller 105 in the transfer canceler 104 for another master of the start of canceling the master on which transfer canceling is to be performed. In response to this, in step 257, the bus interrupter 106 performs bus interruption for the master on which transfer canceling is not to be performed.

After the transfer canceling has been completed, in step 255 the transfer canceling controller 105 notifies the reset controller 113 and the canceling linkage section 200 of the completion of the transfer canceling. In response to this, in step 258 the canceling linkage section 200 notifies the transfer canceling controllers 105 of masters other than the transfer canceled master of the completion of the transfer canceling. In response to this, in step 259, bus interruption is canceled for the masters on which transfer canceling is not to be performed.

Thereafter, in step 261, the reset controller 113 cancels the reset state of the master 101. Thereafter, in step 262, the reset controller 113 instructs the transfer canceling controller 105 to end the transfer canceling state. In response to this, in step 263, the transfer canceling controller 105 instructs the bus interrupter 106 to cancel the bus interruption.

With the above steps, when transfer canceling is being performed on a master (101), commands of the other masters do not reach the shared slave 109 due to bus interruption, whereby a process conflict between a plurality of masters in the shared slave 109 can be reduced, and therefore, a waiting time due to the conflict can be reduced. As a result, a command on which transfer canceling is to be performed can be more quickly erased.

Note that the bus interrupter 106 may have a function of limiting the flow rate of a command and data. As a result, the load of the shared slave 109 can be reduced without completely stopping access performed by a master on which transfer canceling is not to be performed.

In the above flow, bus interruption is performed for all masters on which transfer canceling is not to be performed. Alternatively, for each of the masters, it is selected whether or not bus interruption is to be performed. Alternatively, even if bus interruption is performed for a master on which transfer canceling is not to be performed, bus interruption may not be invariably performed during transfer canceling, and bus interruption may be alternately performed and canceled at predetermined intervals, for example, whereby a period of time during which bus interruption is performed may be reduced. As a result, an influence on a master on which transfer canceling is not to be performed can be reduced.

The slave setting section 125 and the setting switching section 126 of FIG. 1 and the canceling linkage section 200 can coexist and may be simultaneously provided.

### Third Embodiment

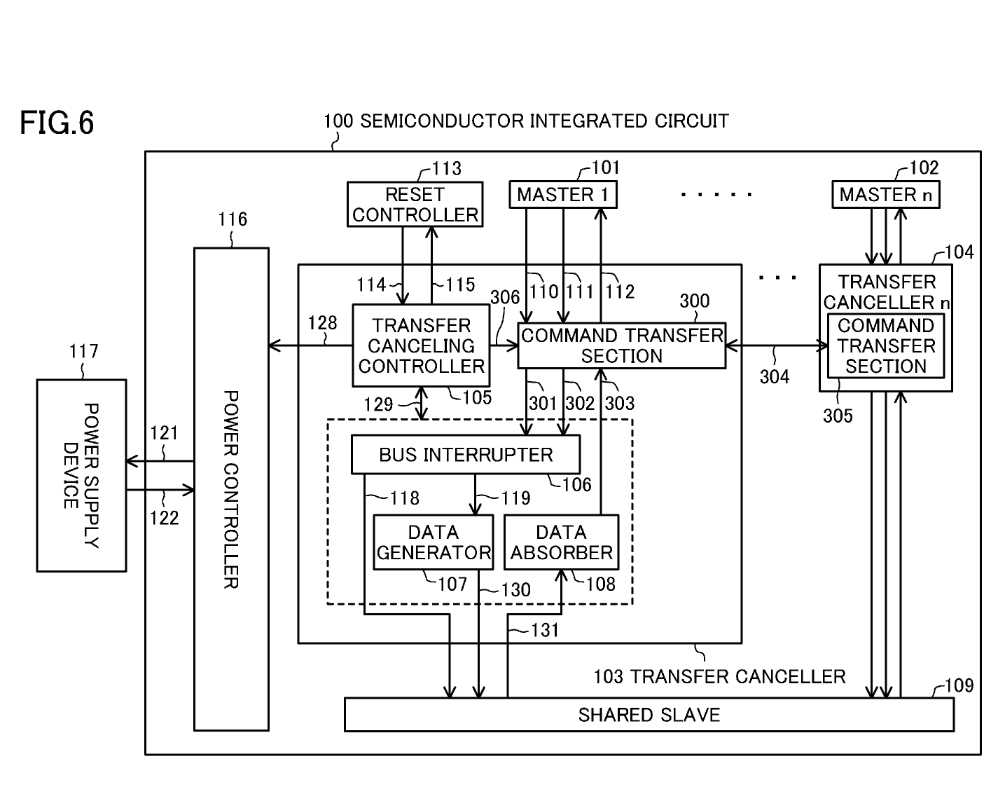

FIG. 6 shows a configuration of an electronic device having a data processing system according to a third embodiment of the present disclosure. In FIG. 6, a command transfer section 300 is provided in the transfer canceler 103 instead of the slave setting section 125 and the setting switching section 126 in the semiconductor integrated circuit 100 of FIG. 1.

The command transfer section 300 has an external connection bus 304 in addition to the buses 110, 111, and 112 from the master 101, and buses 301, 302, and 303 to the bus interrupter 106 and the data absorber 108. The command transfer section 300 has a function of changing connections between the buses 110, 111, and 112 and the buses 301, 302, and 303, and the external connection bus 304. In FIG. 6, the external connection bus 304 is connected to the external connection bus of a command transfer section 305 in the transfer canceler 104 of another master (102). The command transfer section 300 changes the busses, based on an instruction from the transfer canceling controller 105 via a signal line 306, so that data flowing through the buses 110, 111, and 112 is transferred via the external connection bus 304 to the command transfer section 305 of another master. The command transfer section 305 interrupts access from the master 102, and changes the buses so that a command from the command transfer section 300 is sent to the shared slave 109. A command is similarly transferred from the command transfer section 305 to the command transfer section 300.

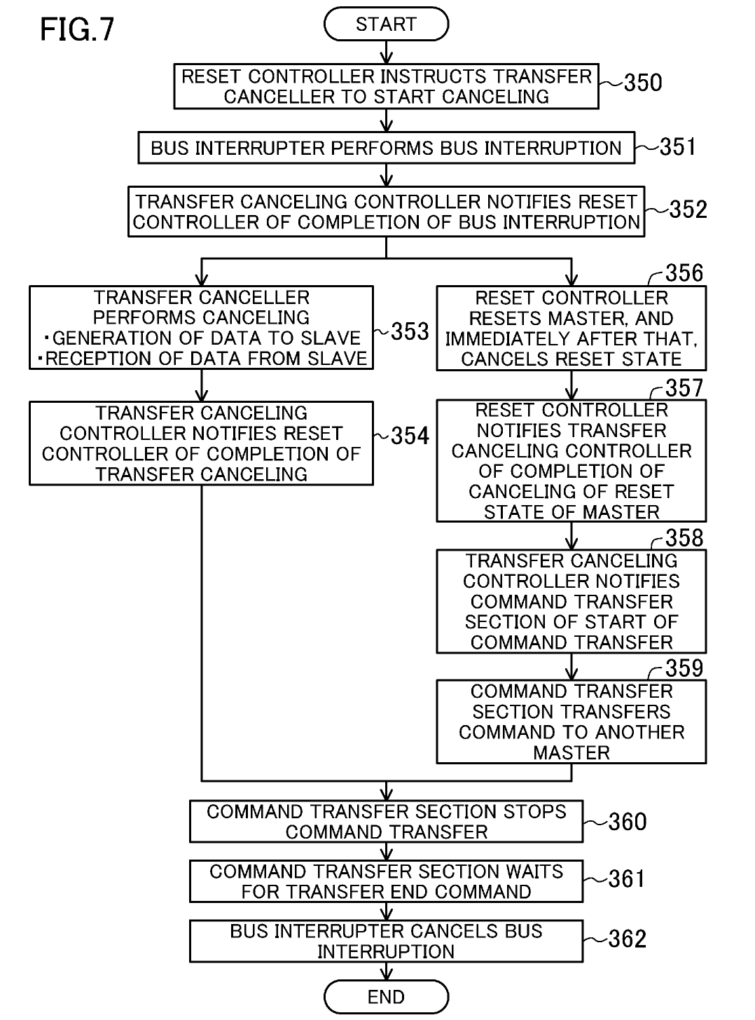

FIG. 7 shows an example flow of transfer canceling and resetting of the master 101 using the mechanism of FIG. 6. Initially, in step 350, the reset controller 113 notifies the transfer canceling controller 105 in the transfer canceler 103, via the signal line 114, that it is necessary to reset the master 101 and therefore transfer canceling is to be performed. In response to this, in step 351, the transfer canceling controller 105 initially instructs the bus interrupter 106 to perform bus interruption, and the bus interrupter 106 performs bus interruption so that invalid data is not transferred from the master 101 to the shared slave 109. After the bus interruption has been completed, in step 352 the transfer canceling controller 105 notifies the reset controller 113 that the bus interruption has been performed.

After the bus interruption has been completed, in step 353 a transfer canceling process is performed. After the transfer canceling has been completed, in step 354 the transfer canceling controller 105 notifies the reset controller 113 of the completion of the transfer canceling. In parallel to steps 353 and 354, the reset controller 113 resets the master 101 in step 356, and thereafter, cancels the reset state without waiting for the completion of the transfer canceling. After the end of canceling the reset state, in step 357 the reset controller 113 notifies the transfer canceling controller 105 of the end of canceling the reset state. In response to this, in step 358 the transfer canceling controller 105 instructs the command transfer section 300 to transfer a command. In response to this instruction, in step 359 the command transfer section 300 transfers a command of the master 101 which has been restored from the reset state to the command transfer section 305 of another master (102). As a result, during transfer canceling, access is performed using a port for another master of the shared slave 109.

After the end of the transfer canceling, the command transfer section 300 stops transferring a command in step 360, and waits for completion of the command transferred to a port for another master in step 361. After all transferred commands have been completed, in step 362 the bus interrupter 106 ends bus interruption, and the master 101 returns to normal operation.

With the above steps, when transfer canceling is being performed on a master (101), it is possible to access the shared slave 109 via a port of another master (102). As a result, before completion of the transfer canceling, the master 101 can be restored to resume accessing, whereby operation of restoring a master from the reset state can be accelerated.

In the above example, a command is transferred using a linkage of the command transfer sections 300 and 305. The external connection bus 304 may be connected to anywhere on the bus connected to the shared slave 109. The shared slave 109 may have a dedicated port for command transfer during transfer canceling. The circuit configuration of the third embodiment can coexist with the circuit configurations of the first and second embodiments.

### Fourth Embodiment

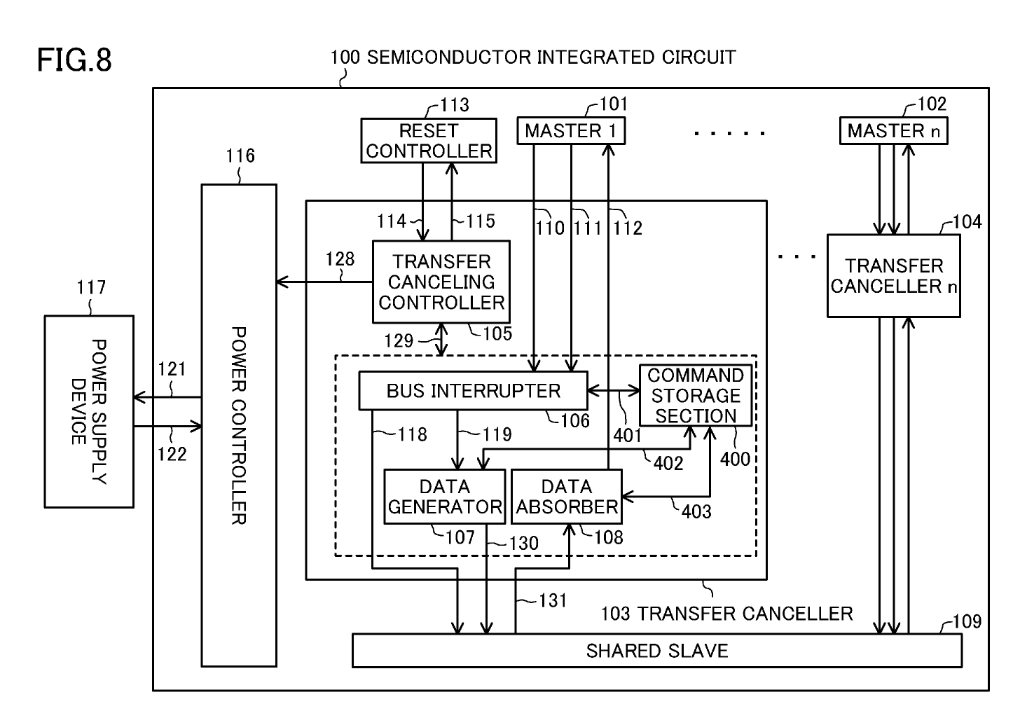

FIG. 8 shows a configuration of an electronic device having a data processing system according to a fourth embodiment of the present disclosure. In FIG. 8, a command storage section 400 is provided instead of the slave setting section 125 and the setting switching section 126 in the semiconductor integrated circuit 100 of FIG. 1.

The command storage section 400 is connected to the bus interrupter 106, the data generator 107, and the data absorber 108 via signal lines 401, 402, and 403, respectively. The command storage section 400 stores a command on which transfer canceling is to be performed, by monitoring a state of each circuit. For example, the command storage section 400 stores the number of pieces of data which have not been issued from the master 101 of write data corresponding to a command which has been issued to the shared slave 109 at the time that the bus interrupter 106 starts bus interruption, and the number of pieces of read data which have not been received from the shared slave 109. Thereafter, the data generator 107 and the data absorber 108 are controlled via the signal lines 401, 402, and 403 so that the data generator 107 generates data and the data absorber 108 absorbs data in amounts corresponding to the stored numbers of pieces of data.

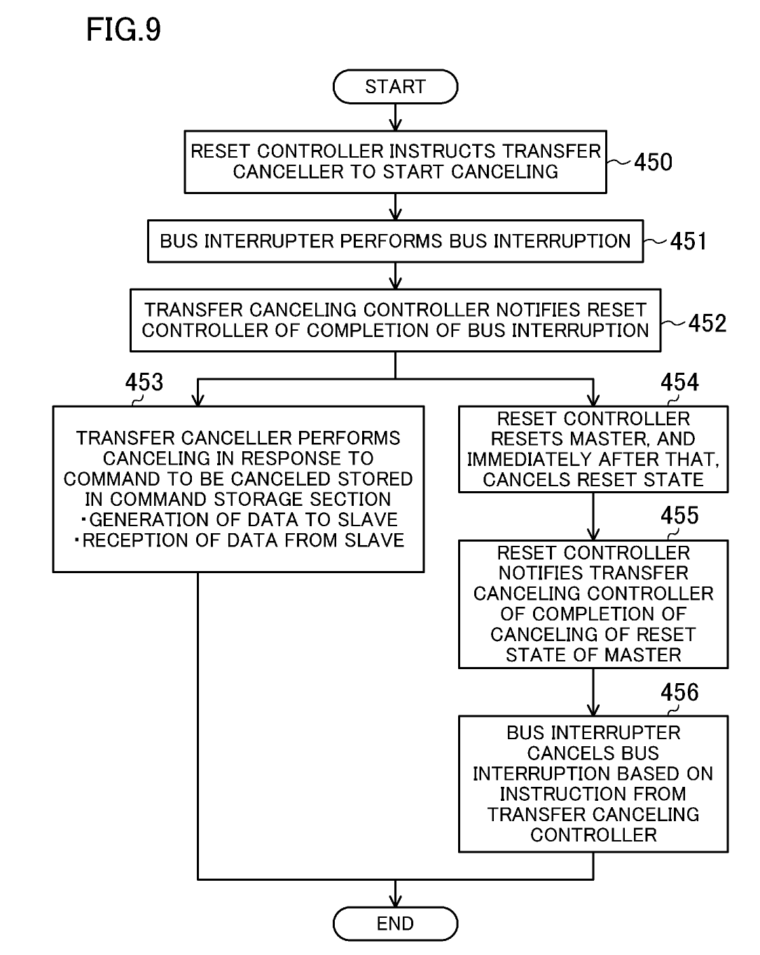

FIG. 9 shows an example flow of transfer canceling and resetting of the master 101 using the mechanism of FIG. 8. Initially, in step 450, the reset controller 113 notifies the transfer canceling controller 105 in the transfer canceler 103, via the signal line 114, that it is necessary to reset the master 101 and therefore transfer canceling is to be performed. In response to this, in step 451, the transfer canceling controller 105 initially instructs the bus interrupter 106 to perform bus interruption, and the bus interrupter 106 performs bus interruption so that invalid data is not transferred from the master 101 to the shared slave 109. After the bus interruption has been completed, in step 452 the transfer canceling controller 105 notifies the reset controller 113 that the bus interruption has been performed.

After the bus interruption has been completed, in step 453 a transfer canceling process is performed. In the transfer canceling process of step 453, a command and data which is to be canceled are selected and erased. In response to this, the reset controller 113 resets the master 101 in step 454, and thereafter, cancels the reset state without waiting completion of the transfer canceling. After the end of canceling the reset state, in step 455 the reset controller 113 notifies the transfer canceling controller 105 of the end of canceling the reset state. In response to this, in step 456 the bus interrupter 106 ends bus interruption, and the master 101 returns to normal operation.

With the above steps, the transfer canceler 103 can select and erase a command which is to be canceled, and therefore, the master 101 can be restored to resume issuing a command to the shared slave 109 without waiting for completion of transfer canceling. As a result, the system can be more quickly restored.

Note that the circuit configuration of the fourth embodiment can coexist with the circuit configurations of the first, second, and third embodiments.

As described above, the data processing system of the present disclosure is useful for a system in which one or a plurality of masters access a slave, particularly, for example, an electronic device having a mechanism of resetting and restoring each master during operation.

What is claimed is:

1. A data processing system comprising:
a plurality of masters and a slave configured to communicate and exchange data with each other;
a plurality of transfer cancelers each interposed between a corresponding one of the plurality of masters and the slave, and configured to, when any of the plurality of masters is in a state in which data transfer operation is disabled, allow the slave to perform and complete operation on behalf of the disabled master or masters; and
a canceling linkage section configured to control a linkage between the plurality of transfer cancelers,
wherein
each of the plurality of transfer cancelers includes
a bus interrupter configured to interrupt command issuance and data output from the corresponding master to the slave,
a data generator configured to generate data to be sent out to the slave in response to a command issued to the slave on behalf of the corresponding master,
a data absorber configured to receive response data from the slave corresponding to the command issued to the slave on behalf of the corresponding master,
a slave setting section configured to generate setting data for setting an operating state of the slave during operation of the data generator and the data absorber,
a setting switching section configured to switch setting data between the setting data generated by the slave setting section and setting data which is used when the data generator and the data absorber are not operating, and
a transfer canceling controller configured to monitor internal states of and control the bus interrupter, the data generator, the data absorber, the slave setting section, and the setting switching section,
the canceling linkage section has a function of collecting internal states of the plurality of transfer cancelers from the respective transfer canceling controllers thereof, and notifying the plurality of transfer cancelers of the internal states, and
the data generator has a function of generating setting data based on the internal states of the plurality of transfer cancelers notified of by the canceling linkage section.

2. The data processing system of claim 1, wherein
the setting data generated by the slave setting section is priority levels at which the plurality of masters access the slave, the priority levels being determined based on the internal states of the plurality of transfer cancelers notified of by the canceling linkage section.

3. The data processing system of claim 2, wherein
the slave setting section increases the priority level of access of one of the plurality of masters to be reset during operation of the data generator and the data absorber, and decreases the priority levels of access of one or more of the plurality of masters not to be reset, based on the internal states of the plurality of transfer cancelers notified of by the canceling linkage section.

4. The data processing system of claim 2, wherein
the slave setting section decreases the priority level of access of the master to be reset, after operation of the data generator and the data absorber.

5. The data processing system of claim 1, wherein
the bus interrupter further has a function of limiting a flow rate of a command and data.

6. An electronic device comprising:
a power supply device; and
a semiconductor integrated circuit having a power control function,
wherein
the semiconductor integrated circuit has the data processing system of claim 1, and controls power supply from the power supply device to each block of the semiconductor integrated circuit based on states of the plurality of transfer cancelers.

7. A data processing system comprising:
a plurality of masters and a slave configured to communicate and exchange data with each other; and
a plurality of transfer cancelers each interposed between a corresponding one of the plurality of masters and the slave, and configured to, when any of the plurality of masters is in a state in which data transfer operation is disabled, allow the slave to perform and complete operation on behalf of the disabled master or masters,
wherein
each of the plurality of transfer cancelers includes
a bus interrupter configured to interrupt command issuance and data output from the corresponding master to the slave,
a data generator configured to generate data to be sent out to the slave in response to a command issued to the slave on behalf of the corresponding master,
a data absorber configured to receive response data from the slave corresponding to the command issued to the slave on behalf of the corresponding master,
a command transfer section configured to change connections between a first bus connected to the master, a second bus connected to the slave, and a third bus, and
a transfer canceling controller configured to monitor internal states of and control the bus interrupter, the data generator, the data absorber, and the command transfer section, and
the command transfer section controls the switching of the bus connections based on the internal states notified of by the transfer canceler.

8. The data processing system of claim 7, wherein
the command transfer section further has a function of stopping data communication with the corresponding master, and performing data communication with the third bus, and
a connection destination of the third bus connected to the command transfer section is the command transfer section of the transfer canceler interposed between one of the plurality of masters other than the corresponding master and the slave.

9. The data processing system of claim 7, wherein
the command transfer section monitors data communication on the first, second, and third buses, and switches the bus connections after completion of the data communication.

10. An electronic device comprising:
a power supply device; and
a semiconductor integrated circuit having a power control function,
wherein
the semiconductor integrated circuit has the data processing system of claim 7, and controls power supply from the power supply device to each block of the semiconductor integrated circuit based on states of the plurality of transfer cancelers.

11. A data processing system comprising:
a master and a slave configured to communicate and exchange data with each other; and
a transfer canceler interposed between the master and the slave, and configured to, when the master is in a state in which data transfer operation is disabled, allow the slave to perform and complete operation on behalf of the master,
wherein
the transfer canceler includes
a bus interrupter configured to interrupt command issuance and data output from the master to the slave,
a data generator configured to generate data to be sent out to the slave in response to a command issued to the slave on behalf of the master,
a data absorber configured to receive response data from the slave corresponding to the command issued to the slave on behalf of the master,
a command storage section configured to store data communication which needs to be performed and completed on behalf of the master, and control the bus interrupter, the data generator, and the data absorber so that the bus interrupter, the data generator, and the data absorber operate only with respect to the stored data communication, and
a transfer canceling controller configured to control the bus interrupter, the data generator, the data absorber, and the command storage section.

12. An electronic device comprising:
a power supply device; and
a semiconductor integrated circuit having a power control function,
wherein
the semiconductor integrated circuit has the data processing system of claim 11, and controls power supply from the power supply device to each block of the semiconductor integrated circuit based on a state of the transfer canceler.

13. A method for resetting a data processing system including a plurality of masters and a shared slave, the method comprising:
a first step of interrupting command issuance and data output from one of the plurality of masters to be reset to the shared slave;
a second step of resetting the master to be reset after completion of the first step;
a third step of, in parallel to the second step, setting an operating state of the shared slave based on internal states of the plurality of masters, generating data to be sent out to the shared slave in response to a command issued to the shared slave and sending out the data to the shared slave on behalf of the master to be reset, and receiving response data from the shared slave corresponding to the command issued to the shared slave on behalf of the master to be reset, thereby allowing the shared slave to perform and complete operation, and
a fourth step of canceling a reset state of the master to be reset after completion of the third step, and canceling the interruption of the command issuance and data output from the master to be reset to the shared slave.

14. A method for resetting a data processing system including a plurality of masters and a shared slave, the method comprising:
a first step of interrupting command issuance and data output from one of the plurality of masters to be reset to the shared slave;
a second step of resetting the master to be reset after completion of the first step;
a third step of, in parallel to the second step, limiting access of the plurality of masters other than the master to be reset based on internal states of the plurality of masters, generating data to be sent out to the shared slave in response to a command issued to the shared slave and sending out the data to the shared slave on behalf of the master to be reset, and receiving response data from the shared slave corresponding to the command issued to the shared slave on behalf of the master to be reset, thereby allowing the shared slave to perform and complete operation, and
a fourth step of canceling a reset state of the master to be reset after completion of the third step, and canceling the interruption of the command issuance and data output from the master to be reset to the shared slave.

15. A method for resetting a data processing system including a plurality of masters and a shared slave, the method comprising:
a first step of interrupting command issuance and data output from one of the plurality of masters to be reset to the shared slave;
a second step of, after completion of the first step, generating data to be sent out to the shared slave in response to a command issued to the shared slave and sending out the data to the shared slave on behalf of the master to be reset, and receiving response data from the shared slave corresponding to the command issued to the shared slave on behalf of the master to be reset, thereby allowing the shared slave to perform and complete operation;
a third step of, in parallel to the second step, resetting the master to be reset and canceling a reset state of the master to be reset, and transferring access from the master to be reset after the canceling of the reset state to the shared slave via a bus other than the interrupted bus; and
a fourth step of, after completion of the second step, stopping issuing new access to the shared slave via a bus other than the interrupted bus in the third step, and canceling the bus interruption after completion of the issued command.

16. A method for resetting a data processing system including a plurality of masters and a shared slave, the method comprising:
a first step of interrupting command issuance and data output from one of the plurality of masters to be reset to the shared slave;
a second step of, after completion of the first step, only with respect to data communication which needs to be performed and completed on behalf of the master to be reset, generating data to be sent out to the shared slave in response to a command issued to the shared slave and sending out the data to the shared slave on behalf of the master to be reset, and receiving response data from the shared slave corresponding to the command issued to the shared slave on behalf of the master to be reset, thereby allowing the shared slave to perform and complete operation; and
a third step of, in parallel to the second step, resetting the master to be reset and canceling a reset state of the master to be reset, and canceling bus interruption so that access from the master to be reset after the canceling of the reset state is permitted.
